(19) United States
(12) Patent Application Publication
(10) Pub. No.: US 2023/0184706 A1
(43) Pub. Date: Jun. 15, 2023

(54) OPTICAL DEVICE AND MEASUREMENT METHOD FOR MEASURING IN-PLANE THERMAL CONDUCTIVITY OF SUB-MILLIMETER-SCALE SAMPLE

(71) Applicant: Huazhong University of Science and Technology, Wuhan (CN)

(72) Inventor: Puqing Jiang, Wuhan (CN)

(21) Appl. No.: 17/980,681

(22) Filed: Nov. 4, 2022

(30) Foreign Application Priority Data
Dec. 14, 2021 (CN) 202111527522.3

(51) Int. Cl. G01N 25/18; G01N 21/17

(52) U.S. Cl. CPC G01N 25/18; G01N 21/1717; G01N 2021/1731; G01N 2201/06113; G01N 2201/0636

(57) ABSTRACT

The present disclosure discloses a measurement method and an optical device for measuring an in-plane thermal conductivity of a sub-millimeter-scale sample. The optical device includes a first continuous-wave laser connected to a signal source; a second continuous-wave laser for outputting a detection laser, wherein a half-wave plate, a polarized beam splitter, a quarter-wave plate, a dichroic mirror, an objective lens, reflectors, a balanced photodetector, and a lock-in amplifier are sequentially arranged along an optical path of the detection laser, wherein the dichroic mirror is configured to allow transmission of the detection laser and reflection of the heating laser; the polarized beam splitter reflects part of the detection laser to the balanced photodetector and the detection laser reflected from the sample is reflected to the balanced photodetector, the balanced photodetector converts a laser signal into an electrical signal; the lock-in amplifier extracts an amplitude and a phase of the electrical signal.

### CROSS REFERENCE TO RELATED APPLICATION

This patent application claims the benefit and priority of Chinese Patent Application No. 202111527522.3, filed on Dec. 14, 2021, the disclosure of which is incorporated by reference herein in its entirety as part of the present application.

### TECHNICAL FIELD

The present disclosure relates to the technical field of thermal conductivity measurement, particularly an optical device and measurement method for measuring the in-plane thermal conductivity of a sub-millimeter-scale sample.

### BACKGROUND ART

In industry and scientific research, characterizing the thermal conductivity of a small-sized sample is frequently needed. For example, in the nuclear industry, when the thermal conductivity of a radioactive material needs to be measured, the sample size needs to be as small as possible, usually in the order of sub-millimeter-scale, to reduce the radiation amount of the sample since the radiation amount is proportional to the cube of the sample size. Another example is that many new materials are being developed in the semiconductor industry, such as boron nitride, bismuth selenide, and graphene fluoride. Yet, due to the limitation of the synthesizing techniques, these materials cannot be made into centimeter-scale large-sized samples to meet the sample size requirements of conventional thermal measurement methods such as steady state, laser flash, and protective thermal plate.

The pump-probe thermoreflectance technique, which uses laser beams to heat a sample and detect the temperature response, has unique advantages in measuring the thermal properties of small-sized samples. Existing pump-probe thermoreflectance techniques include time-domain thermoreflectance (TDTR) and frequency-domain thermoreflectance (FDTR). Wherein TDTR, which is based on an ultrafast femtosecond pulsed laser, is not only expensive and complex for the system but also causes great difficulties in the measurement due to the instability of the electric-optical modulator thereof. FDTR, based on continuous-wave lasers, is much simpler in the system and has a lower cost than TDTR. Still, the measurement accuracy of FDTR is seriously affected by the phase adjustment of the pump laser. More importantly, since the modulation frequency ranges of both TDTR and FDTR are limited, they cannot measure the in-plane thermal conductivity lower than 10 W/(m·K). In addition, TDTR and FDTR also have a problem in that their measured thermal conductivities could depend on the laser spot size and the modulation frequency.

### SUMMARY

Concerning the defects or improvement requirements mentioned above of the current thermal measurement techniques, this disclosure provides an optical device and a measurement method for measuring the in-plane thermal conductivity of a sub-millimeter-scale sample. The device and method can measure the in-plane thermal conductivity of a sub-millimeter-scale sample with a dramatically extended measurable thermal conductivity range of 1˜2000 W/(m˜K).

To achieve the above goals, according to one aspect of the present disclosure, the present disclosure provides an optical device for measuring the in-plane thermal conductivity of a sub-millimeter-scale sample. The device includes a first continuous-wave laser, connected to a signal source for outputting a heating laser modulated at a preset frequency, and a second continuous-wave laser, configured for outputting a detection laser in a polarized state. A half-wave plate, a polarized beam splitter, a quarter-wave plate, a dichroic mirror, and an objective lens are sequentially disposed along the optical path of the detection laser. The device further includes reflectors, a balanced photodetector, and a lock-in amplifier. The wavelength of the heating laser is different from that of the detection laser, so the dichroic mirror can be configured to allow transmission of the detection laser and reflection of the heating laser. The objective lens focuses both the heating laser and the detection laser on the sample surface, wherein the heating laser heats the sample periodically, and the detection laser detects the temperature response of the sample surface. The polarized beam splitter reflects part of the detection laser directly to one input port of the balanced photodetector for reference. The rest of the detection laser passes through the polarized beam splitter and detects the temperature on the surface of the heated sample. The detection laser reflected from the surface of the heated sample is then reflected into another input port of the balanced photodetector by the reflectors. An output of the lock-in amplifier is connected to the first continuous-wave laser to modulate the first continuous-wave laser at a preset frequency, and an input of the lock-in amplifier is connected to the balanced photodetector to measure amplitudes and phases of electrical signals from the output of the balanced photodetector.

Preferably, the angle of the dichroic mirror can be adjusted to realize the heating of different parts of the sample.

Preferably, the device further includes a filter. The filter is arranged between the reflectors and the balanced photodetector and is configured for filtering the heating laser from the reflected laser of the sample.

Preferably, the wavelength of the detection laser is 532 nm or 785 nm.

Preferably, the thermal diffusion length in the sample caused by the heating laser is greater than or equal to three times the laser spot radius.

According to another aspect of the present disclosure, a measurement method is provided for the optical device for measuring the in-plane thermal conductivity of sub-millimeter-scale samples described above. The method includes: S1: coating a metal film on the surface of the sample to be measured; S2: adjusting the angle of the dichroic mirror so that the heating laser heats the surface of the sample at different positions; recording amplitude signals and phase signals extracted by the lock-in amplifier as a function of the offset distance between the heating laser and the detection laser on the surface of the sample; S3: subtracting the group of phase signals as a function of offset distance by its value at zero offset to obtain a group of measured differential phase signals as a function of offset distance; dividing the group of amplitude signals as a function of offset distance by its value at zero offset to obtain a group of measured normalized amplitude signals as a function of offset distance; S4: inputting a preset initial value of the in-plane thermal conductivity of the sample to be measured and a preset initial value of the laser spot size into a heat transfer model to obtain a group of calculated normalized amplitude signals as a function of offset distance, and comparing the calculated with the measured normalized amplitude signals and continuously adjusting the laser spot size until a deviation between the two groups of normalized amplitude signals is less than a first preset value, so as to obtain a quasi-laser spot size; S5: adjusting the value of the in-plane thermal conductivity until the deviation between the group of calculated differential phase signals obtained by the thermal transfer model and the measured ones are less than a second preset value, so as to obtain a quasi in-plane thermal conductivity; S6: inputting the quasi-laser spot size and the quasi in-plane thermal conductivity into the heat transfer model again to update the calculated normalized amplitude signals and the calculated differential phase signals, and repeatedly executing steps S4˜S5; for both the laser spot size and the in-plane thermal conductivity, if the deviation between the newly obtained value and the one from the previous fitting is less than a preset value, then stopping iteration, or else repeatedly executing step S6.

Preferably, the thickness of the metal film is 50˜150 nm; the thermal conductivity of the metal film is less than ten times the thermal conductivity of the sample to be measured.

Preferably, when the wavelength of the detection laser is 532 nm, the metal film is made of one of Mo, Ta, and Au or an alloy thereof; when the wavelength of the detection laser is 785 nm, the metal film is made of one of Al, Pt, Ta, and NbV or an alloy thereof.

Preferably, when an in-plane anisotropic material is measured, the number of the angles of the dichroic mirror adjusted in step S2 is at least three.

Preferably, the heat transfer model is:

Z(x_{c},y_{c},ω)=∫_{-∞}^{∞}∫_{-∞}^{∞}Ĝ(u,v,ω)exp(−π²(u²wₓ²+v²w_{y}²))exp(i2π(ux_{c}+vy_{c}))du dv

The phase signal φ is:

$$φ = arc tan \{ \frac{Im [ Z ( {x}_{c} , {y}_{c} , ω ) ]}{Re [ Z ( {x}_{c} , {y}_{c} , ω ) ]} \}$$

The amplitude signal A is:

A=|Z(x_{c},y_{c},ω)|

where u, v are integral variables, wₓ is the averaged laser spot radius of the heating laser and the detection laser in the x direction, w_{y} is the averaged laser spot radius of the heating laser and the detection laser in the y direction, x_{c} is the offset distance of the detection laser spot relative to the heating laser spot in the x direction, y_{c} is the offset distance of the detection laser spot relative to the heating laser spot in they direction, Ĝ(u, v, ω) is the Green function of a multilayer sample structure and is defined as the temperature rise of the surface of the sample as a result of the application of a unit intensity heat flux to the surface of the sample in the frequency domain, i=\sqrt{−1} is an imaginary number, ω=2πf, and f is the modulation frequency of the heating laser.

In general, compared with the prior art, by means of the above technical solutions conceived of by the present disclosure, the present disclosure provides an optical device and a measurement method for measuring the in-plane thermal conductivity of a sub-millimeter-scale sample, which have the following beneficial effects:

1. The present disclosure uses a heating laser and a detection laser for thermal measurement such that the required size of the sample is only 0.1 mm in diameter and 0.1 μm in thickness. Through a novel analysis of the differential phase signals and the normalized amplitude signals, the present technique dramatically expands the measurable in-plane thermal conductivity to a broad range from 1 to 2000 W/(m·K).

2. In the present disclosure, the heating laser is modulated at a specific frequency, and the detection laser is linearly polarized. The wavelength of the heating laser and the detection laser is different so that a dichroic mirror reflects the heating laser and transmits the detection laser. Both the heating laser and the detection laser are focused onto the surface of the sample by an objective lens. Measurements of isotropic and anisotropic materials can be achieved by adjusting the angle of the dichroic mirror so that the heating laser scans the surface of the sample. The detection laser reflected back by the sample is received by the balanced photodetector and converted into an electrical signal, with the amplitude and phase extracted by a lock-in amplifier. The device of the present disclosure has several advantages, including a significantly reduced system cost, ease of operation since the reference phase of the heating laser does not need to be corrected, and higher measurement accuracy.

3. The technique of the present disclosure can measure the intrinsic thermal conductivity of a material, unlike the TDTR and FDTR techniques, whose measurement results can depend on the choice of modulation frequency and laser spot size.

4. In the method of the present disclosure, the measurement error of the in-plane thermal conductivity obtained through the iterative fitting of the accurately measured amplitude and phase signals can be controlled within 5%, thereby significantly improving the measurement accuracy of thermal conductivity.

### BRIEF DESCRIPTION OF THE DRAWINGS

FIG. 1 is a schematic diagram of an optical device for measuring the in-plane thermal conductivity of a sub-millimeter-scale sample in an embodiment of the present disclosure;

FIG. 2 is a measurement principle diagram of an optical device for the in-plane thermal conductivity measurement of a sub-millimeter-scale sample in an embodiment of the present disclosure;

FIGS. 3A-3B is an example of the measured results of an amorphous silica sample measured by the technique of the present disclosure for extracting the in-plane thermal conductivity and laser spot size,

FIGS. 4A-4B is an example of the measured results of the in-plane thermal conductivity tensor of an in-plane anisotropic quartz sample measured by the technique of the present disclosure.

Throughout the drawings, the same reference numerals are configured to refer to the same elements or structures, wherein:

1—first continuous-wave laser, 2—second continuous-wave laser, 3—dichroic mirror, 4—objective lens, 5—quarter-wave plate, 6—polarized beam splitter, 7—half-wave plate, 8—filter, 9—balanced photodetector, 10—lock-in amplifier, 11—sample, 12—reflector.

### DETAILED DESCRIPTION OF THE EMBODIMENTS

To make the objects, technical solutions, and advantages of the present disclosure clearer, the following further describes the present disclosure in detail with reference to the accompanying drawings and embodiments. It should be understood that the embodiments described herein are only intended to explain the present disclosure but not to limit the present disclosure. In addition, technical features involved in various embodiments of the present disclosure described below may be combined as long as they do not conflict.

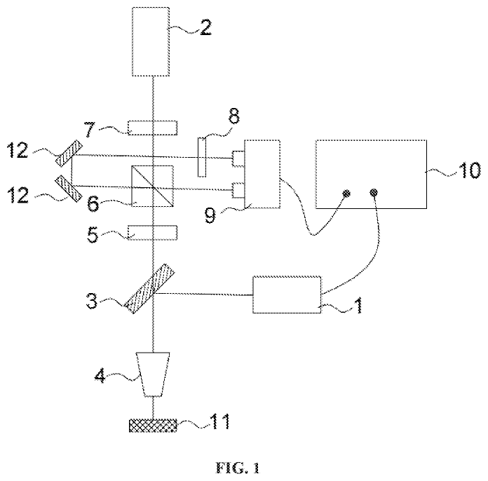

Referring to FIG. 1, the present disclosure provides an optical device for measuring the in-plane thermal conductivity of a sub-millimeter-scale sample. The device includes a first continuous-wave laser 1, a second continuous-wave laser 2, a dichroic mirror 3, an objective lens 4, a quarter-wave plate 5, a polarized beam splitter 6, a half-wave plate 7, a balanced photodetector 9, a lock-in amplifier 10, and reflectors 12.

The first continuous-wave laser 1 is connected to an external signal source and is controlled by the external signal source to output a continuous-wave laser modulated by a sine wave with a preset frequency, that is, a heating laser.

The second continuous-wave laser 2 is configured to output a detection laser in a polarized state, and a half-wave plate 7, a polarized beam splitter 6, a quarter-wave plate 5, a dichroic mirror 3, and a microscope objective 4 are sequentially disposed along an optical path of the detection laser.

The heating laser output from the first continuous-wave laser 1 is focused onto the surface of a sample 11 by the microscope objective 4 after being reflected by the dichroic mirror 3, thereby heating the surface of the sample.

The wavelength of the detection laser is different from that of the heating laser. The dichroic mirror 3 reflects the heating laser but allows transmission of the detection laser. After passing through the dichroic mirror 3, the detection laser is focused on the surface of the sample 11 by the objective lens 4, thereby detecting the surface of the sample. The angle of the dichroic mirror 3 can be adjusted, which can realize scanning on the surface of the sample by the heating laser, so that the amplitude signals and phase signals of the heating laser and the detection laser at different relative offset positions can be obtained.

The device further includes reflectors 12, a balanced photodetector 9, and a lock-in amplifier 10. The balanced photodetector 9 is configured to convert an optical signal into an electrical signal, and the lock-in amplifier 10 is configured to extract amplitudes and phases from electrical signals.

The polarized beam splitter 6 reflects part of the detection laser directly to one input port of the balanced photodetector 9 and reflects the reflected detection laser from the sample to another input port of the balanced photodetector 9 via the reflectors 12; the lock-in amplifier 10 is connected to the first continuous-wave laser 1 and the balanced photodetector 9 for modulating the frequency of the first continuous-wave laser 1 and measuring amplitudes and phases of the output electrical signals of the balanced photodetector 9.

The half-wave plate 7, the polarized beam splitter 6, and the quarter-wave plate 5 can be configured in combination to adjust the laser intensity ratio of the two input ports of the balanced photodetector 9, and the signal noise can be minimized when the laser intensities of the two input ports are equal. The device further includes a filter 8, installed before the balanced photodetector 9 to block the heating laser and allow transmission of the detection laser.

The thermal diffusion length of the heating laser should be greater than or equal to three times the laser spot radius thereof. The frequency of the first continuous-wave laser 1 can be selected based on the laser spot radius and the in-plane thermal diffusivity of the sample to be measured, so that the thermal diffusion length d_{f} is not less than three times the laser spot radius w, where d_{f}=\sqrt{k/(πfC)}, and k is the in-plane thermal conductivity of the sample, f is the modulation frequency of the heating laser, and C is the volumetric heat capacity of the sample, w=\sqrt{(wₕ²+wₚ²)/2}, wₕ and wₚ are the 1/e² radii of the heating laser spot and the detection laser spot on the surface of the sample, respectively.

In practice, a metal film must be deposited on the sample's surface to serve as a transducer. The thickness of the metal film should be in the range 50˜150 nm, and the thermal conductivity of the metal film should be less than ten times that of the sample to be measured.

The wavelength of the detection laser is preferably 532 nm or 785 nm. Further, when the wavelength of the detection laser is 532 nm, the metal film can be one of Mo, Ta, and Au or an alloy thereof; when the wavelength of the detection laser is 785 nm, the metal film can be one of Al, Pt, Ta, and NbV or an alloy thereof.

The amplitude and phase signals extracted by the lock-in amplifier 10 are normalized and differentiated, respectively. The measured differential phase signals and normalized amplitude signals as a function of offset distance between the heating laser spot and the detection laser spot are then analyzed by using a heat transfer model so that the in-plane thermal conductivity of the sample in the scanning direction and the laser spot size can be extracted. The in-plane thermal conductivity tensor of the sample can be obtained by iteratively fitting the amplitudes and phase signals in three different scanning directions when measuring in-plane anisotropic materials.

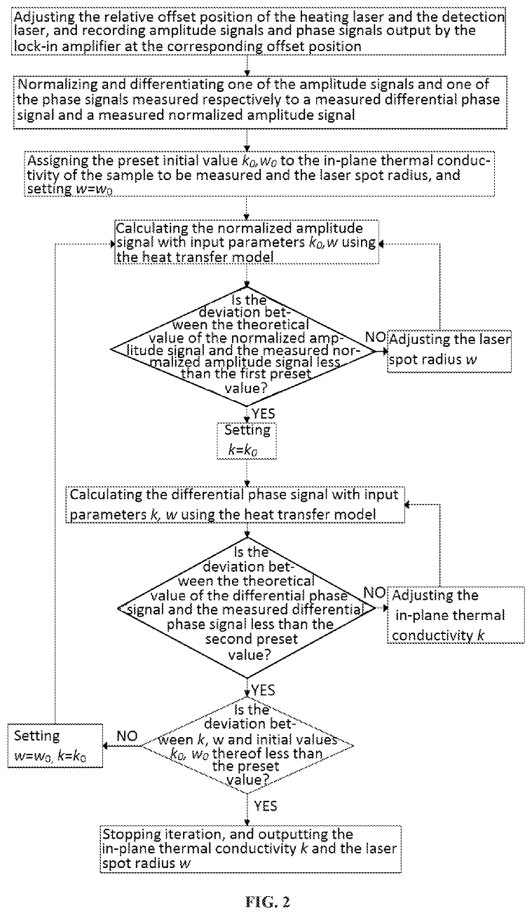

Another aspect of the present disclosure provides a measurement method for the optical device for measuring the in-plane thermal conductivity of a sub-millimeter-scale sample described above. The method includes the following steps S1˜S6, as shown in FIG. 2, specifically as follows:

S1: coating a metal film on the surface of a sample to be measured.

The thickness of the metal film is preferably 50˜150 nm.

The thermal conductivity of the metal film is less than ten times the thermal conductivity of the sample to be measured, and when the wavelength of the detection laser is 532 nm, the material of the metal film is one of Mo, Ta, and Au or an alloy thereof; when the wavelength of the detection laser is 785 nm, the material of the metal film is one of Al, Pt, Ta, and NbV or an alloy thereof.

S2: adjusting the angle of the dichroic mirror 3 so that the heating laser heats the surface of the sample to be measured at different positions, and recording the amplitude and phase signals extracted by the lock-in amplifier 10, as a function of offset distance between the heating laser and the detection laser spots on the sample surface.

When an in-plane isotropic material is measured, only one scan along any direction is needed for thermal analysis. When an in-plane anisotropic material is measured, scans along at least three different directions are needed; furthermore, the three different directions distinguished by 45° such as 0°, 90° and 45° are preferred to obtain the three components kₓₓ, k_{yy} and k_{xy} of the in-plane thermal conductivity tensor.

S3: subtracting the group of phase signals as a function of offset distance by its value at zero offset to obtain a group of measured differential phase signals as a function of offset distance; dividing the group of amplitude signals as a function of offset distance by its value at zero offset to obtain a group of measured normalized amplitude signals as a function of offset distance.

S4: inputting a preset initial value of the in-plane thermal conductivity of the sample to be measured and a preset initial value of the laser spot size into the heat transfer model to obtain a group of normalized amplitude signals as a function of offset distance, and comparing the calculated with the measured normalized amplitude signals, and continuously adjusting the laser spot size until the deviation between the two groups of normalized amplitude signals is less than a first preset value, so as to obtain a quasi-laser spot size.

The heat transfer model is:

Z(x_{c},y_{c},ω)=∫_{-∞}^{∞}∫_{-∞}^{∞}Ĝ(u,v,ω)exp(−π²(u²wₓ²+v²w_{y}²))exp(i2π(ux_{c}+vy_{c}))du dv

The phase signal φ is:

$$φ = arc tan \{ \frac{Im [ Z ( {x}_{c} , {y}_{c} , ω ) ]}{Re [ Z ( {x}_{c} , {y}_{c} , ω ) ]} \}$$

The amplitude signal A is:

A=|Z(x_{c},y_{c},ω)|

where u, v are integral variables, and wₓ is the value of the average laser spot radius of the heating laser and the detection laser in the x direction, w_{y} is the averaged laser spot radius of the heating laser and the detection laser in the y direction, x_{c} is the offset distance of the detection laser spot relative to the heating laser spot in the x direction, y_{c} is the offset distance of the detection laser spot relative to the heating laser spot in the y direction, Ĝ(u, v, ω) is the Green function of the multilayer sample structure and is defined as the temperature rise of the surface of the sample as a result of the application of a unit intensity heat flux to the surface of the sample in the frequency domain, i=\sqrt{−1} is an imaginary number, ω=2πf, and f is the modulation frequency of the heating laser.

S5: adjusting the value of the in-plane thermal conductivity until the deviation between the group of calculated differential phase signals obtained by the thermal transfer model and the measured ones are less than a second preset value, so as to obtain a quasi in-plane thermal conductivity.

S6: inputting the quasi-laser spot size and the quasi in-plane thermal conductivity into the heat transfer model again to update the calculated normalized amplitude signals and the calculated differential phase signals, and repeatedly executing steps S4˜S5; for both the laser spot size and the in-plane thermal conductivity, if the deviation between the newly obtained value and the one from the previous fitting is less than a preset value, then stopping iteration, or else repeatedly executing step S6. The preset value is preferably 1%.

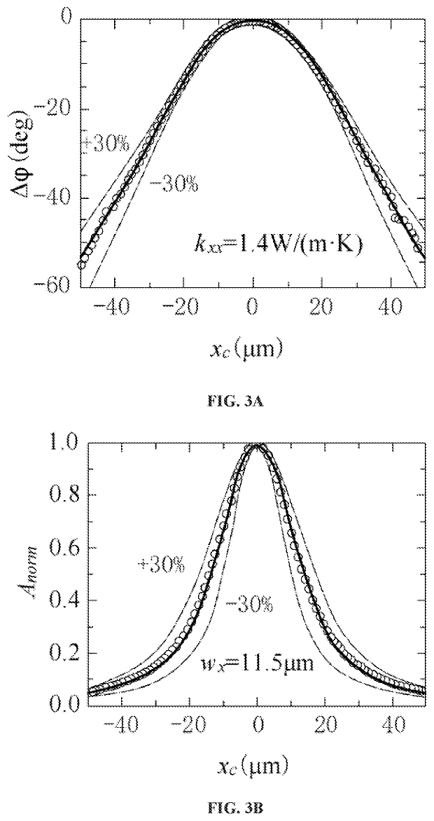

FIGS. 3A-3B shows signal measurement and analysis of an amorphous silica sample conducted in accordance with the present disclosure. The dots are measurement signals, the thick solid line is a signal calculated by a heat transfer model under an optimal fit value, and the dotted line is a signal calculated by the heat transfer model when deviating from the optimal fit value by ±30%, showing the degree of sensitivity of a measurement signal to an in-plane thermal conductivity and a laser spot radius to be fitted in FIGS. 3A-3B. In this group of measurements, the surface of the amorphous silicon sample is coated with a Ti film with a thickness of 100 nm, the modulation frequency of the pump laser is 150 Hz, and the wavelength of the detection laser is selected to be 660 nm. By simultaneously fitting the differential phase signal shown in FIG. 3A and the normalized amplitude signal shown in FIG. 3B, the in-plane thermal conductivity of amorphous silica sample in the scanning direction was measured to be 1.4±0.05 W/(m·K), while the laser spot radius was measured to be 11.5±0.2 μm. Since the amorphous silica is an isotropic material, the in-plane thermal conductivity of amorphous silica sample in any direction is 1.4±0.05 W/(m·K) according to this group of measurements.

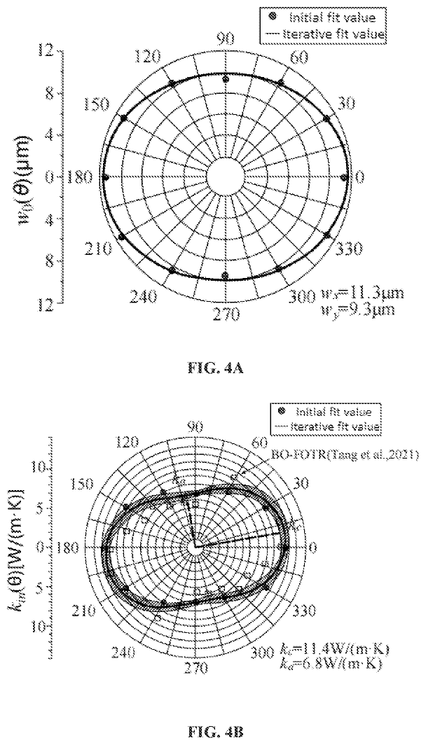

FIGS. 4A-4B shows the measurement results of an in-plane anisotropic quartz sample conducted in accordance with the present disclosure. First, offset scans are performed every 30°, and best fittings are performed on the differential phase signals and normalized amplitude signals measured in each scanning direction, as shown in FIG. 2 and FIGS. 3A-3B, respectively, to obtain initial fitting values of the laser spot radii and the in-plane thermal conductivities of the sample in each scanning direction, plotted as solid dots in FIGS. 4A-4B, respectively. Signals scanned at three different directions, 0°, 30°, and 90°, are selected here for an iterative fitting. The signals scanned in the direction of 0° are fitted to extract the component kₓₓ of an in-plane thermal conductivity tensor, the signals scanned in the direction of 90° are fitted to extract the component k_{yy} of the in-plane thermal conductivity tensor, and the signals scanned in the direction of 30° are fitted to extract the component k_{xy} of the in-plane thermal conductivity tensor. Finally, the thermal conductivity in any direction θ of the sample can be determined as kᵢₙ(θ)=kₓₓ cos²θ+k_{yy} sin²θ+k_{xy} sin 2θ, and plotted as the solid line in FIG. 4B. The uncertainty of kᵢₙ(θ) is shown by the shaded area in FIG. 4B. A beam-offset frequency-domain thermoreflectance developed in the document ([Tang and Dames, Int. J. Heat Mass Transf., Vol 164, 120600, 2021]) also measures the in-plane anisotropic thermal conductivity of quartz, and their measurement results are plotted as open squares in FIG. 4B. Overall, the measurement results conducted according to the present disclosure are consistent with the literature measurement results. However, the present measurement results in different directions are less discrete and have much-reduced measurement uncertainty, thereby demonstrating the superiority of the present disclosure. In addition, it can be seen from FIG. 4A that the laser spot configured in the present measurement conducted according to the present disclosure is slightly oval, with the long axis radius being 11.3 μm and the short axis radius being 9.3 μm. However, this does not affect the accurate measurement of the in-plane thermal conductivities measured by the present disclosure. The present disclosure can process the oval spot well, thereby relaxing the requirements for the shape of the laser spot in the optical device.

Those skilled in the art will readily appreciate that the foregoing descriptions are only preferred embodiments of the present disclosure and are not intended to limit the present disclosure, and any modifications, equivalent replacements, improvements, and the like within the spirit and principle of the present disclosure shall belong to the scope of the present disclosure.

What is claimed is:

1. A measurement method for an optical device for measuring an in-plane thermal conductivity of a sub-millimeter-scale sample, the optical device comprising:
a first continuous-wave laser (1), connected to a signal source for outputting a heating laser modulated at a preset frequency;
a second continuous-wave laser (2), configured for outputting a detection laser in a polarized state, a half-wave plate (7), a polarized beam splitter (6), a quarter-wave plate (5), a dichroic mirror (3) and an objective lens (4) are sequentially arranged along an optical path of the detection laser;
wherein a wavelength of the heating laser is different from that of the detection laser, so the dichroic mirror (3) allows transmission of the detection laser and reflection of the heating laser, wherein the heating laser heats a sample to be measured, and the detection laser detects temperature response of a surface of a heated sample;
the optical device further comprises reflectors (12), a balanced photodetector (9), and a lock-in amplifier (10), wherein the polarized beam splitter (6) reflects part of the detection laser directly to the balanced photodetector (9), and the detection laser reflected from the surface of the heated sample is reflected to the balanced photodetector (9) via the reflectors (12); the lock-in amplifier (10) is connected to the first continuous-wave laser (1) to modulate the first continuous-wave laser at a preset frequency, and the lock-in amplifier is connected to the balanced photodetector (9) to measure amplitudes and phases of electrical signals from an output of the balanced photodetector (9),
wherein the measurement method comprises:
S1: coating a metal film on a surface of the sample to be measured;
S2: adjusting an angle of the dichroic mirror (3) so that the heating laser heats the surface of the sample to be measured at different positions, and recording amplitude signals and phase signals extracted by the lock-in amplifier (10) as a function of offset distances between the heating laser and the detection laser on the surface of the sample
S3: subtracting a group of the phase signals by its value at zero offset to obtain a group of measured differential phase signals; dividing a group of amplitude signals by its value at zero offset to obtain a group of measured normalized amplitude signals;
S4: inputting a preset initial value of the in-plane thermal conductivity of the sample to be measured and a preset initial value of a laser spot size into a heat transfer model to obtain a group of calculated normalized amplitude signals as a function of the offset distance, and comparing the calculated with the measured normalized amplitude signals, and continuously adjusting the laser spot size until a deviation between the two groups of normalized amplitude signals is less than a first preset value, so as to obtain a quasi-laser spot size;
S5: adjusting a value of the in-plane thermal conductivity until a deviation between a group of calculated differential phase signals obtained by the thermal transfer model and the measured ones are less than a second preset value, so as to obtain a quasi in-plane thermal conductivity;
S6: inputting the quasi-laser spot size and the quasi in-plane thermal conductivity into the heat transfer model again to update the calculated normalized amplitude signals and the calculated differential phase signals, and repeatedly executing steps S4˜S5; for both the laser spot size and the in-plane thermal conductivity, if a deviation between a newly obtained value and the one obtained by previous fitting is less than a preset value, then stopping iteration, or else repeatedly executing step S6.

2. The measurement method according to claim 1, wherein, the angle of the dichroic mirror (3) is adjustable, so as to realize heating of different parts of the sample.

3. The measurement method according to claim 1, wherein, the optical device further comprises a filter (8) arranged between the reflectors (12) and the balanced photodetector (9) and is configured for filtering the heating laser reflected from the sample.

4. The measurement method according to claim 1, wherein, a wavelength of the detection laser is 532 nm or 785 nm.

5. The measurement method according to claim 1, wherein, a thermal diffusion length in the sample caused by the heating laser is greater than or equal to three times a laser spot radius thereof.

6. The measurement method according to claim 1, wherein, a thickness of the metal film is 50˜150 nm; a thermal conductivity of the metal film is less than ten times the thermal conductivity of the sample to be measured.

7. The measurement method according to claim 6, wherein, when a wavelength of the detection laser is 532 nm, the metal film is made of one of Mo, Ta, and Au or an alloy thereof; when the wavelength of the detection laser is 785 nm, the metal film is made of one of Al, Pt, Ta, and NbV or an alloy thereof.

8. The measurement method according to claim 1, wherein, when an in-plane anisotropic material is measured, a number of the angle of the dichroic mirror adjusted in step S2 is at least three.

9. The measurement method according to claim 1, wherein, the heat transfer model is:
Z(x_{c},y_{c},ω)=∫_{-∞}^{∞}∫_{-∞}^{∞}Ĝ(u,v,ω)exp(−π²(u²wₓ²+v²w_{y}²))exp(i2π(ux_{c}+vy_{c}))du dv
the phase signal φ is:
$$φ = arc tan \{ \frac{Im [ Z ( {x}_{c} , {y}_{c} , ω ) ]}{Re [ Z ( {x}_{c} , {y}_{c} , ω ) ]} \}$$
the amplitude signal A is:
A=|Z(x_{c},y_{c},ω)|

where u, v are integral variables, and wₓ is an averaged laser spot radius of the heating laser and the detection laser in an x direction, w_{y} is the averaged laser spot radius of the heating laser and the detection laser in a y direction, x_{c} is the offset distance of a detection laser spot relative to a heating laser spot in the x direction, y_{c} is the offset distance of the detection laser spot relative to the heating laser spot in the y direction, Ĝ(u, v, ω) is a Green function of a multilayer sample structure and is defined as a temperature rise of the surface of the sample as a result of the application of a unit intensity heat flux to the surface of the sample in the frequency domain, i=\sqrt{−1} is an imaginary number, ω=2πf, and f is a modulation frequency of the heating laser.
